(19) United States
(12) Patent Application Publication
(10) Pub. No.: US 2020/0341119 A1
(43) Pub. Date: Oct. 29, 2020

(54) ACTIVELY ALIGNED SOLID-STATE LIDAR SYSTEM

(71) Applicant: Continental Automotive Systems, Inc., Auburn Hills, MI (US)

(72) Inventors: Elliot Smith, Ventura, CA (US); James Robert Massie, Santa Barbara, CA (US)

(73) Assignee: Continental Automotive Systems, Inc., Auburn Hills, MI (US)

(21) Appl. No.: 16/395,598

(22) Filed: Apr. 26, 2019

(51) Int. Cl. G01S 7/481; G01S 7/497; G01S 17/93; G01S 7/486; G01S 17/89

(52) U.S. Cl. CPC G01S 7/4813; G01S 7/4972; G01S 7/4814; G01S 17/89; G01S 17/936; G01S 7/4863; G01S 7/4816

(57) ABSTRACT

A Lidar system includes a casing, a light emitter stationary relative to the casing, and a photodetector pivotally supported by the casing. The system includes a reflector assembly and the light emitter is aimed at the reflector assembly. The reflector assembly includes a rotational shaft and a reflector is fixed to the rotational shaft. A rotational motor is engaged with the rotational shaft. The aim of the photodetector may be adjusted, and the rotational motor may independently adjust the reflector assembly to correspondingly aim the reflector assembly.

### BACKGROUND

A solid-state Lidar system includes a photodetector, or an array of photodetectors that is essentially fixed in place relative to a carrier, e.g., a vehicle. Light is emitted into the field of view of the photodetector and the photodetector detects light that is reflected by an object in the field of view. For example, a Flash Lidar system emits pulses of light, e.g., laser light, into essentially the entire field of view. The detection of reflected light is used to generate a 3D environmental map of the surrounding environment. The time of flight of the reflected photon detected by the photodetector is used to determine the distance of the object that reflected the light.

The solid-state Lidar system may be mounted on a vehicle to detect objects in the environment surrounding the vehicle and to detect distances of those objects for environmental mapping. The output of the solid-state Lidar system may be used, for example, to autonomously or semi-autonomously control operation of the vehicle, e.g., propulsion, braking, steering, etc. Specifically, the system may be a component of or in communication with an advanced driver-assistance system (ADAS) of the vehicle.

Since the solid-state Lidar system is fixed in place relative to the vehicle, ride-height and/or angle of the vehicle can change the aim of the field of view. The ride-height and/or angle of the vehicle may change, e.g., from changes in weight and/or center of gravity. This may be caused by, for example, varying weight, location, and/or age of occupants, varying weight and/or location of cargo, changes in an active-suspension system of the vehicle, changes in an active-ride-handling system of the vehicle, etc. Difficulties can arise in properly aiming the vertically-narrow field of view during such changes in the vehicle and over the lifetime of the vehicle.

### BRIEF DESCRIPTION OF THE DRAWINGS

FIG. 1 is a perspective view of a vehicle with a Lidar system showing a 3D map of the objects detected by the Lidar system.

FIG. 2 is a perspective view of the Lidar system including a casing (shown in hidden lines) and a housing that houses a photodetector and pivots relative to the casing.

FIG. 3 is a perspective view of another embodiment of the Lidar system including a casing and a housing that houses a photodetector and pivots relative to the casing.

FIG. 4 is a perspective view of the Lidar system of FIG. 3 with the casing shown in hidden lines.

FIG. 5 is a cross-sectional view along line 5 in FIG. 3.

FIG. 6 is a cross-sectional view along line 6 in FIG. 3.

FIG. 7 is a perspective view of another embodiment of the Lidar system including a casing (shown in hidden lines) and a housing that houses a photodetector and pivots relative to the casing.

FIG. 8 is a cross-sectional view of the system in FIG. 7.

FIG. 9 is a schematic of the operation of the embodiment in FIGS. 7 and 8.

FIG. 10 is a cross-sectional view of another embodiment of the Lidar system.

FIG. 11 is a schematic of the operation of the embodiment in FIG. 10.

FIG. 12 is an embodiment of a rotational motor and reflector assembly.

FIG. 13 is another embodiment of a rotational motor and reflector assembly.

FIG. 14 is another embodiment of a rotational motor and reflector assembly.

FIG. 15 is a block diagram of the Lidar system in FIG. 3.

FIG. 16 is a flow chart of a method for the Lidar system.

### DETAILED DESCRIPTION

With reference to the Figures, wherein like numerals indicate like parts throughout the several views, a system 10 is generally shown. Specifically, the system 10 is a light detection and ranging (Lidar) system. The system 10 includes a casing 12, a light emitter 14 stationary relative to the casing 12, and a photodetector 16 pivotally supported by the casing 12. The system 10 includes a rotational motor 18 supported by the casing 12. A reflector assembly 20 includes a rotational shaft 22 and a reflector 24 fixed to the rotational shaft 22. The rotational shaft 22 is engaged with the rotational motor 18 and the reflector 24 is fixed to the rotational shaft 22. The light emitter 14 is aimed at the reflector assembly 20. The photodetector 16 may be pivoted relative to the casing 12 to adjust a field of view FOV of the photodetector 16 and the rotational shaft 22 may be turned to adjust a field of illumination FOI created by the light emitter 14 to align the field of illumination FOI with the field of view FOV.

The system 10 independently adjusts the aim of the field of illumination FOI and the aim of the field of view FOV to align the field of illumination FOI and the field of view FOV. This alignment may be performed repeatedly and in the field, i.e., during use of the system 10, such that the system 10 can recalibrate the relative positions of the field of illumination FOI and field of view FOV in the field, e.g., before, during, and/or after operation. For example, the system 10 may be mounted on a vehicle 26 and the alignment of the field of illumination FOI and the field of view FOV may be performed at any suitable time, e.g., before, during, and/or after operation of the vehicle 26.

As set forth further below, the system 10 may include more than one photodetector 16, more than one light emitter 14, and more than one reflector 24 on the rotational shaft 22. For each of these components, common numerals are used to identify the elements and separate alphabetical identifiers are used to distinguish the common elements.

The system 10 may vertically adjust the field of illumination FOI and the field of view FOV. As examples, changes in the ride-height and/or angle of the vehicle 26 may be caused by changes in weight, center of gravity of the vehicle 26. This may be caused by, for example, varying weight, location, and/or age of occupants, varying weight and/or location of cargo, changes in an active-suspension system of the vehicle 26, changes in an active-ride-handling system of the vehicle 26, etc. In such an event, the field of view FOV may be vertically adjusted to a desired vertical position, and the field of illumination FOI may be independently vertically adjusted to align the field of illumination FOI with the field of view FOV. Specifically, due to the requirement of a high-resolution Lidar system, the height of the vertical aim of the field of view FOV may be limited, and the system 10 allows for adjustment of the vertical aim of the system 10. This improves the system 10 requirements on the field of view FOV. The system 10 adjusts the field of illumination FOI to align with the field of view FOV.

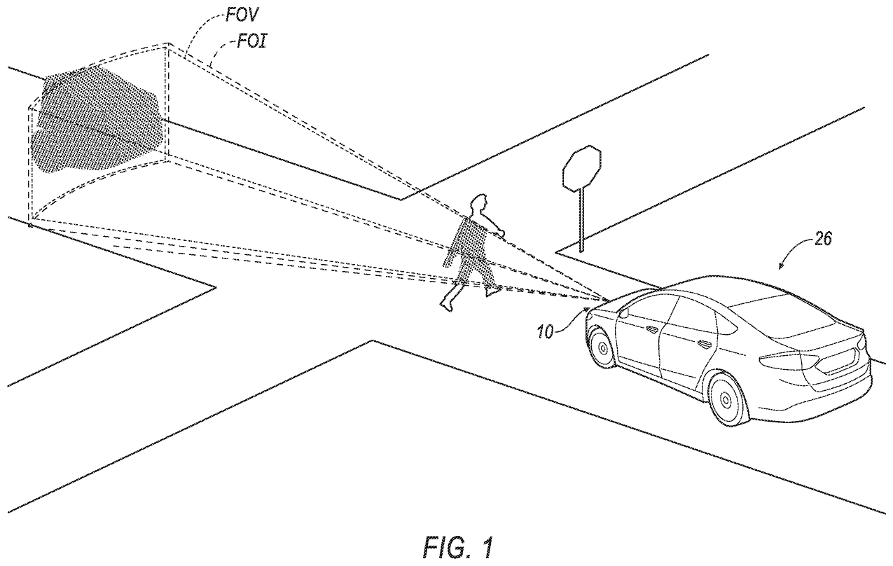

The system 10 detects the emitted light that is reflected by an object in the fields of view FOV, e.g., pedestrians, street signs, vehicles, etc. The system 10 is shown in FIG. 1 as being mounted on a vehicle 26. In such an example, the system 10 is operated to detect objects in the environment surrounding the vehicle 26 and to detect distance of those objects for environmental mapping. The output of the system 10 may be used, for example, to autonomously or semi-autonomously control operation of the vehicle 26, e.g., propulsion, braking, steering, etc. Specifically, the system 10 may be a component of or in communication with an advanced driver-assistance system (ADAS) of the vehicle 26. The system 10 may be mounted on the vehicle 26 in any suitable position (as one example, the system 10 is shown on the front of the vehicle 26 and directed forward). The vehicle 26 may have more than one system 10 and/or the vehicle 26 may include other object detection systems, including other Lidar systems. The vehicle 26 is shown in FIG. 1 as including a single system 10 aimed in a forward direction merely as an example. The vehicle 26 shown in the Figures is a passenger automobile. As other examples, the vehicle 26 may be of any suitable manned or un-manned type including a plane, satellite, drone, watercraft, etc.

The system 10 may be a solid-state Lidar system. In such an example, the system 10 is stationary relative to the vehicle 26. For example, the casing 12 that is fixed relative to the vehicle 26, i.e., does not move relative to the component of the vehicle 26 to which the casing 12 is attached, and a silicon substrate of the system 10 is supported by the casing 12.

As a solid-state Lidar system 10, the system 10 may be a flash Lidar system. In such an example, the system 10 emits pulses of light into the field of illumination FOI. More specifically, the system 10 may be a 3D flash Lidar system 10 that generates a 3D environmental map of the surrounding environment, as shown in part in FIG. 1. An example of a compilation of the data into a 3D environmental map is shown in the field of view FOV and the field of illumination FOI in FIG. 1.

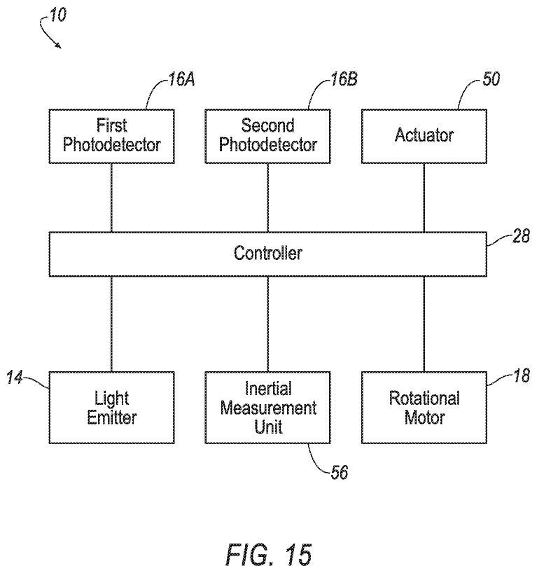

With reference to FIG. 15, the system 10 may include a controller 28. The controller 28 is in communication with the light emitter 14 and the rotational motor 18 for controlling the emission of light from the light emitter 14 and the aim of the field of illumination FOI. The controller 28 may be in communication with the photodetector 16 for receiving detection of reflected light in the field of view FOV.

Specifically, the controller 28 may instruct the light emitter 14 to emit light and substantially simultaneously initiates a clock. When the light is reflected, i.e., by an object in the field of view FOV, the photodetector 16 detects the reflected light and communicates this detection to the controller 28, which the controller 28 uses to identify object location and distance to the object (based time of flight of the detected photon using the clock initiated at the emission of light from the light source). Each photodetector 16 may operation in this fashion. The controller 28 uses these outputs from the photodetectors 16 to create the environmental map and/or communicates the outputs from the photodetectors 16 to the vehicle 26, e.g., components of the ADAS, to create the environmental map. Specifically, the controller 28 continuously repeats the light emission and detection of reflected light for building and updating the environmental map.

The controller 28 may be a microprocessor-based controller or field programmable gate array (FPGA), or a combination of both, implemented via circuits, chips, and/or other electronic components. In other words, the controller 28 is a physical, i.e., structural, component of the system 10. For example, the controller 28 may include a processor, memory, etc. The memory of the controller 28 may store instructions executable by the processor, i.e., processor-executable instructions, and/or may store data. The controller 28 may be in communication with a communication network of the vehicle 26 to send and/or receive instructions from the vehicle 26, e.g., components of the ADAS.

With reference to FIG. 1, the light emitter 14 emits light into fields of illumination FOI for detection by the photodetector 16 when the light is reflected by an object in the field of view FOV. The light emitter 14 may be, for example, a laser. The light emitter 14 may be, for example, a semiconductor laser. In one example, the light emitter 14 is a vertical-cavity surface-emitting laser (VCSEL). As another example, the light emitter 14 may be a diode-pumped solid-state laser (DPSSL). As another example, the light emitter 14 may be an edge emitting laser diode. The light emitter 14 may be designed to emit a pulsed flash of light, e.g., a pulsed laser light. Specifically, the light emitter 14, e.g., the VCSEL or DPSSL or edge emitter, is designed to emit a pulsed laser light. The light emitted by the light emitter 14 may be, for example, infrared light. Alternatively, the light emitted by the light emitter 14 may be of any suitable wavelength. The system 10 may include any suitable number of light emitters, i.e., one or more in the casing 12. In examples that include more than one light emitter 14, the light emitters 14 may be identical or different.

As set forth above, the light emitter 14 is aimed at the reflector assembly 20. In other words, light from the light emitter 14 is reflected by one of the reflectors 24 of the reflector assembly 20. The light emitter 14 may be aimed directly at the reflector assembly 20 or may be aimed indirectly at the reflector assembly 20 through intermediate reflectors/deflectors, diffusers, optics, etc.

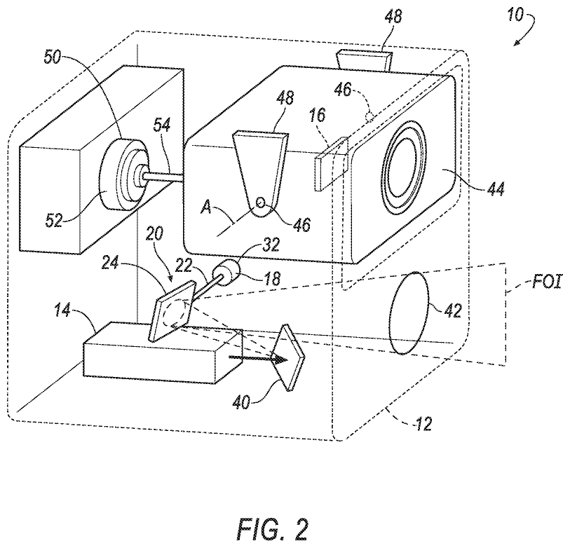

With reference to FIG. 2, the light emitter 14 may be stationary relative to the casing 12. In other words, the light emitter 14 does not move relative to the casing 12 during operation of the system 10, e.g., during light emission. The light emitter 14 may be mounted to the casing 12 in any suitable fashion such that the light emitter 14 and the casing 12 move together as a unit.

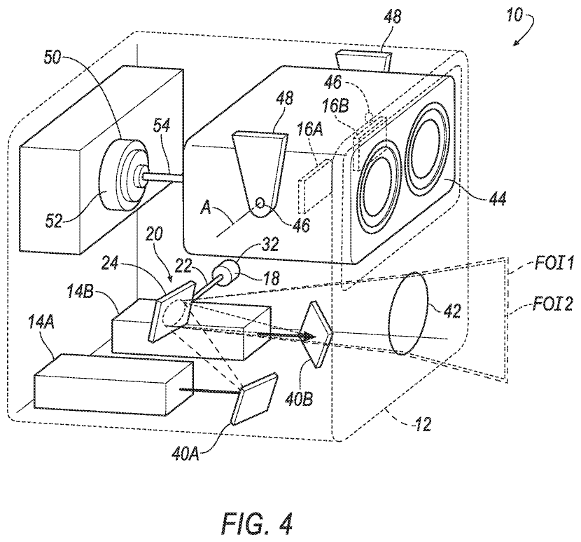

The system 10 includes one or more cooling devices 30 for cooling the light emitter 14. For example, the system 10 may include a heat sink (shown in FIG. 4) on the casing 12 adjacent the light emitter 14. The heat sink may include, for example, a wall adjacent the light emitter 14 and fins extending away from the wall exterior to the casing 12 for dissipating heat away from the light emitter 14. The wall and/or fins, for example, may be material with relatively high heat conductivity. The light emitter 14 may, for example, abut the wall to encourage heat transfer. In addition or in the alternative, the fins, the system 10 may include additional cooling devices 30, e.g. thermal electric coolers (TEC).

With reference to FIG. 2, the reflector 24 of the reflector assembly 20 is aimed at the field of view FOV of the photodetector 16. In other words, the field of illumination FOI from the reflector 24 overlaps the field of view FOV of the photodetector 16, e.g., the field of illumination FOI is centered on the field of view FOV. The reflector 24 may directly reflect light from the light emitter 14 to the field of illumination FOI or may indirectly reflect light to the field of illumination FOI, i.e., through intermediate reflectors/deflectors, optics, etc. In examples that include more than one reflector 24, the reflectors 24 may be identical or different.

As set forth above, the assembly includes a rotational motor 18 supported by the casing 12. The rotational shaft 22 of the reflector assembly 20 is engaged with the rotational motor 18. In other words, the rotational motor 18 rotates the rotational shaft 22 for moving the reflector 24 on the rotational shaft 22. The rotational motor 18 may be fixed directly to the casing 12 or may be supported by the casing 12 through an intermediate component. A base 32 of the rotational motor 18 may be fixed relative to the casing 12. The rotational motor 18 may be controlled by the controller 28, as described below. The rotational motor 18 may be an electric motor. For example, the rotational motor 18 may be a step motor or a piezoelectric motor.

As set forth above, the reflector 24 is fixed to the rotational shaft 22. In other words, the reflector 24 moves as a unit with the rotational shaft 22. The reflector 24 may be a mirror (e.g., a mirror with a stationary reflective surface), a reflective diffuser, etc.

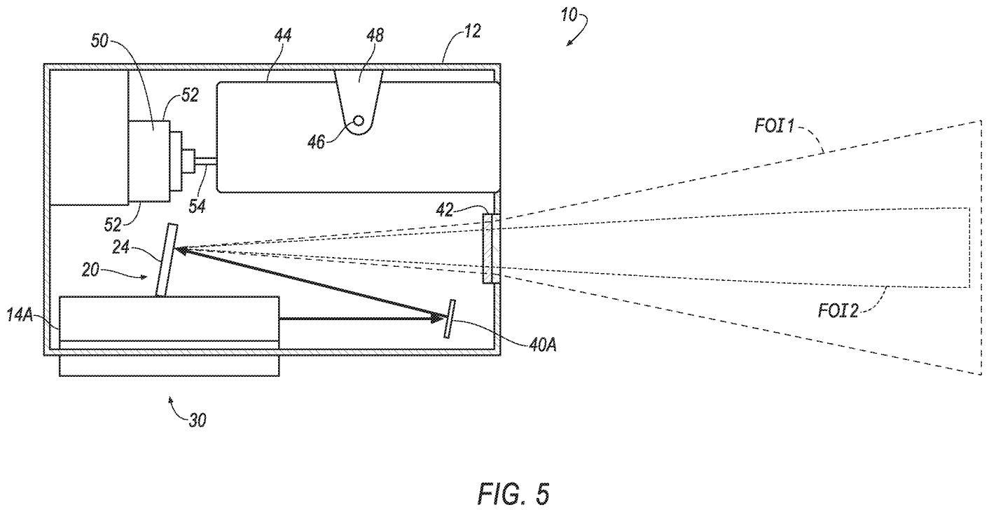

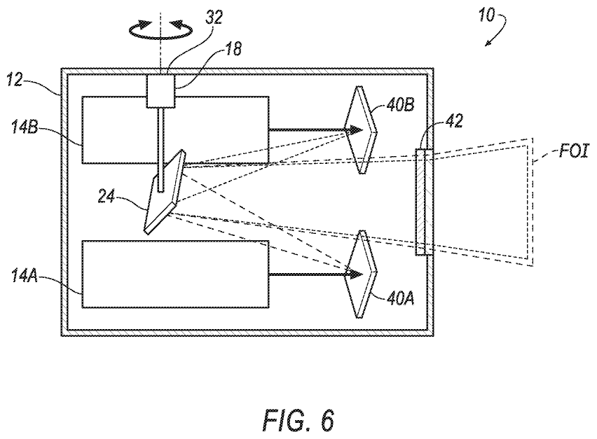

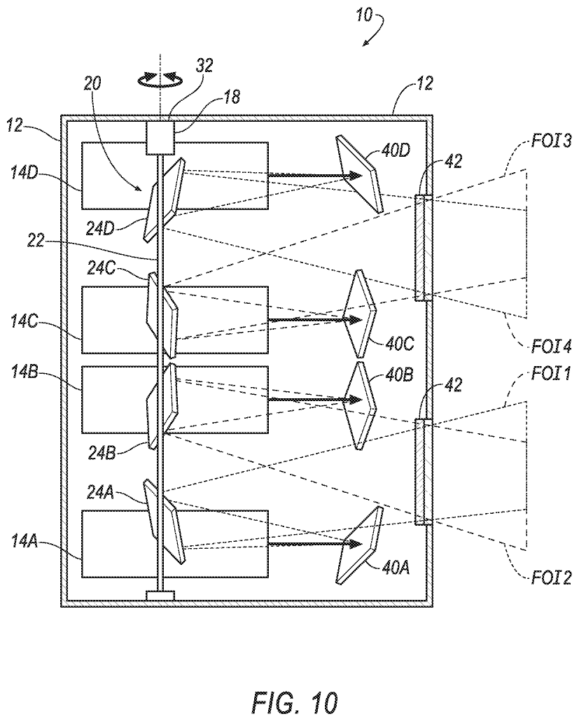

The rotational shaft 22 is driven by the rotational motor 18. The rotational shaft 22 has an end that engages the rotational motor 18, i.e., is driven by the rotational motor 18. The other end of the shaft may be free, i.e., cantilevered (e.g., see FIGS. 1, 5, 6) or may be supported by the casing 12, i.e., in addition to being supported at the rotational motor 18 (e.g., see FIGS. 8 and 10).

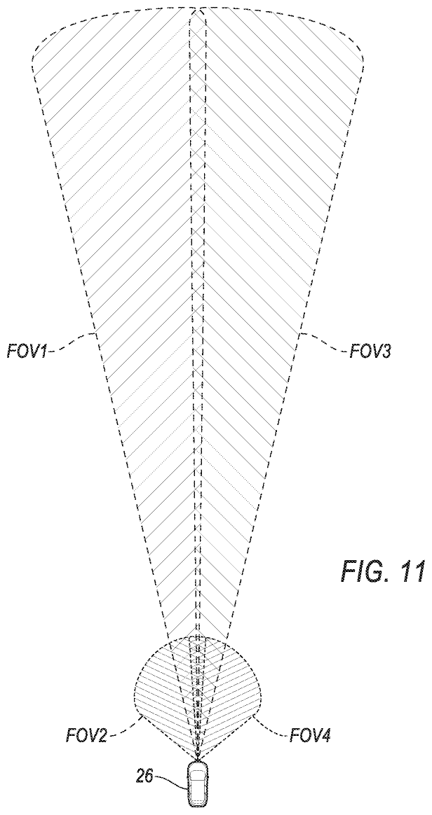

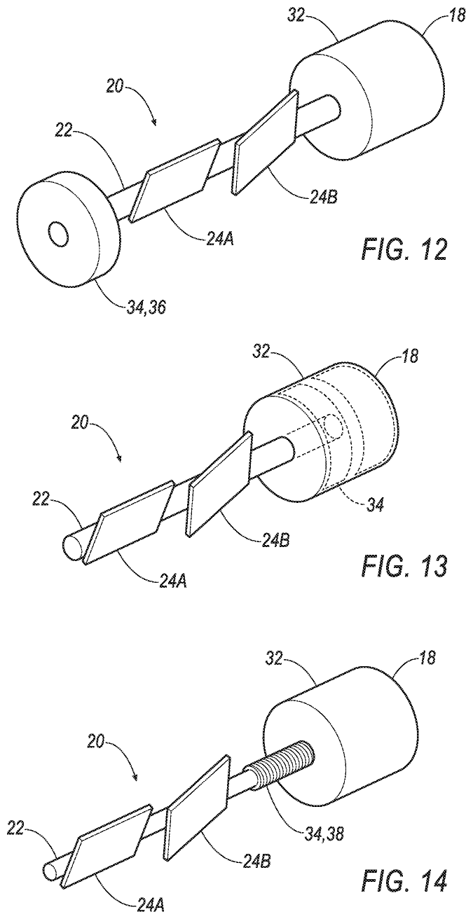

With reference to FIGS. 12-14, the rotational motor 18 and/or the reflector assembly 20 may include a vibration dampener 34 engaged with the rotational shaft 22. The vibration dampener 34 is designed to dampen high-frequency vehicle vibration. High-frequency vehicle vibration may be caused by operation of the vehicle 26, i.e., driving of the vehicle 26 on a driving surface. The high-frequency vehicle vibration is caused by the wheels of the vehicle 26 rolling on the driving surface and is affected by other components of the vehicle 26 such as suspension system components. This dampening of the high-frequency vehicle vibration limits or eliminates vibration of the reflector 24 during operation of the vehicle 26. The vibration dampener 34 may be between the rotational motor 18 and the rotational shaft 22, e.g., FIGS. 13 and 14.

With reference to FIG. 12, the vibration dampener 34 may be a dampening housing 36 that receives the rotational shaft 22. Specifically, one end of the rotational shaft 22 is driving by the motor and the other end of the rotational shaft 22 is engaged with the dampening housing 36. The dampening housing 36 may include hydraulic gearing, a roller vane, an orbiting gerotor, a radial piston, a rotary abutment, etc., for dampening vibration in the rotational shaft 22.

As another example, with reference to FIG. 13, the vibration dampener 34 may be housed in the base 32 of the rotational motor 18. In such an example, an end of the rotational shaft 22 that engages the rotational motor 18 also engages the vibration dampener 34. The rotational shaft 22 may have a free end, i.e., a cantilevered end. The vibration dampener 34 in the housing 44 of the rotational motor 18 may include hydraulic gearing, a roller vane, an orbiting gerotor, a radial piston, a rotary abutment, etc., for dampening vibration in the rotational shaft 22.

As another example, with reference to FIG. 14, the vibration dampener 34 may be a torsion spring 38 fixed to the rotational motor 18 and the rotational shaft 22. In this example, the torsion spring 38 is loaded to exert a bias against the rotational shaft 22 to dampen vibration in the rotational shaft 22.

With reference to FIG. 2, the system 10 may include a stationary reflectors 40 fixed relative to the casing 12 (see FIGS. 2, 4-8, 10). As an example, the stationary reflector 40 may be between the light emitter 14 and the reflector 24 of the reflector assembly 20. In such an example, the stationary reflector 40 is aimed at the reflector 24 of the reflector assembly 20 to reflect light from the light emitter 14 to the reflector 24 of the reflector assembly 20. The stationary reflector 40 may be, for example, a reflective diffuser, a mirror, etc. As another example, in the alternative to the stationary reflectors 40, the light emitter 14 may be directly aimed at the reflector 24. In examples that include more than one stationary reflector 40, the stationary reflectors 40 may be identical or different.

The system 10 may include a refractive diffuser 42 fixed to the casing 12. The reflector 24 of the reflector assembly 20 is aimed at the refractive diffuser 42 and the refractive diffuser 42 diffuses light into the field of illumination FOI.

The photodetector 16 is in the casing 12. The system 10 may also include receiving optics, e.g., lenses, filters, etc., fixed to the casing 12 and designed to receive reflected light from the field of view FOV.

The photodetector 16 has a field of view FOV. In examples that include more than one photodetector 16, at least some of the photodetectors 16 may be aimed in different directions. As another example, some photodetectors 16 may be aimed in the same direction to provide overlapping fields of view FOV, in which case one field of view FOV may be longer than the other, e.g., for long-range and short-range detection. In examples that include more than one light emitter 14, the light emitters 14 may be identical or different.

For the purpose of this disclosure “photodetector” includes a single photodetector 16 or an array of photodetectors (including 1D arrays, 2D arrays, etc.). The photodetector 16 may be, for example, an avalanche photodiode detector or PIN detector. As one example, the photodetector 16 may be a single-photon avalanche diode (SPAD). The field of view FOV is the area in which reflected light may be sensed by the photodetector 16. Light reflected in the field of view FOV is reflected to the photodetector 16, e.g., through receiving optics.

As set forth above, the reflector 24 of the reflector assembly 20 reflects light from the light emitter 14 into a field of illumination FOI. The field of illumination FOI is the area exposed to light that is emitted from the light-transmitting unit. The field of illumination FOI is aimed to overlap the field of view FOV. In other words, as least part of the field of view FOV and at least part of the field of illumination FOI occupy the same space such that an object in the overlap will reflect light from the field of illumination FOI back to the photodetector 16. The field of illumination FOI may be smaller than, larger than, or substantially match the same size as the field of view FOV (“substantially match” is based on manufacturing capabilities and tolerances of the light-transmitting unit and the light-receiving unit).

The system 10 aligns the field of view FOV of the photodetector 16 and the field of illumination FOI of the transmitter 14. In other words, the system 10 positions the field of view FOV and the field of illumination FOI to a desired relative position, e.g., vertically adjusts the field of view FOV and field of illumination FOI. As one example, the field of view FOV and the field of illumination FOI are “aligned” when positioned such that the maximum intensity of reflected light in the field of view FOV is detected by the photodetector 16. The field of view FOV and the field of illumination FOI may be centered to the positions that provide the maximum detected intensity.

The system 10 independently adjusts the vertical aim of the field of illumination FOI and the vertical aim of the field of view FOV to align the field of illumination FOI and the field of view FOV. This alignment may be performed repeatedly and in the field, i.e., during use of the system 10, such that the system 10 can recalibrate the relative positions of the field of illumination FOI and field of view FOV in the field, e.g., before, during, and/or after operation. For example, the system 10 may be mounted on a vehicle 26 and the alignment of the field of illumination FOI and the field of view FOV may be performed at any suitable time, e.g., before, during, and/or after operation of the vehicle 26. As examples, changes in the ride-height and/or angle of the vehicle 26 may be caused by changes in weight, center of gravity of the vehicle 26. This may be caused by, for example, varying weight, location, and/or age of occupants, varying weight and/or location of cargo, changes in an active-suspension system of the vehicle 26, changes in an active-ride-handling system of the vehicle 26, etc. In such an event, the field of view FOV may be adjusted to a desired vertical position, and the field of illumination FOI may be independently adjusted to align the field of illumination FOI with the field of view FOV. Specifically, due to the requirement of a high-resolution Lidar system, the height of the vertical aim of the field of view FOV may be limited, and the system 10 allows for adjustment of the vertical aim of the system 10. This improves the system 10 requirements on the field of view FOV. The system 10 adjusts the field of illumination FOI to align with the field of view FOV.

For example, with reference to FIGS. 1-11, the system 10 includes a housing 44 that supports the photodetector 16. In other words, the photodetector 16 is fixed relative to the housing 44 and moves as a unit with the housing 44. The housing 44 is pivotally supported about a horizontal axis A by the casing 12. Accordingly, the housing 44 can be pivoted (i.e., tilted, swiveled, etc.) relative to the housing 44 to simultaneously adjust the vertical aim of the photodetector 16. Specifically, the housing 44 may be pivotally engaged with the casing 12, i.e., directly in contact with the housing 44, or may be coupled to the housing 44 through an intermediate component.

Specifically, the housing 44 is pivotable relative to the casing 12 about a horizontal axis A, i.e., can swivel, tilt, etc., about the horizontal axis A. Specifically, horizontal pivot points 46, i.e., pivot points 46 that allow for pivoting about a horizontal axis A, connect the housing 44 to the casing 12. The horizontal pivot points 46 are spaced from each other along a horizontal axis A. The casing 12 and/or the housing 44 may include brackets 48 that support the horizontal pivot points 46.

The housing 44 may be horizontally fixed to the casing 12, i.e., does not move relative to the casing 12 about a vertical axis. As another example, the housing 44 may be movable relative to the casing 12 about a vertical axis to horizontally selectively steer the field of illumination FOI, and in such an example, the housing 44 may be movable through a fixed range of angles, e.g., less than 180° . In other words, system 10 is not a 360° scanning system 10.

The system 10 may include an actuator 50 between the housing 44 and the casing 12. The actuator 50 is configured to pivot the photodetector 16 relative to the casing 12, i.e., to vertically adjust the photodetector 16. The actuator 50 is between the housing 44 and the casing 12 for pivoting the housing 44 relative to the casing 12. For example, the actuator 50 may be fixed to the casing 12 and the housing 44 to move the casing 12 and the housing 44 relative to each other about the horizontal pivot points.

The actuator 50 may be, for example, an electric motor. As one example, the actuator 50 may include a base 52 fixed to one of the casing 12 and the housing 44 and a plunger 54 fixed to the other of the casing 12 and the housing 44. The actuator 50 may be powered to retract the plunger 54 into the base or extend the plunger 54 from the base 52 to move the housing 44 relative to the casing 12. In such an example, the actuator 50 is spaced from the horizontal pivot points 46 such that force exerted between the casing 12 and the housing 44 by the actuator 50 moves the casing 12 and the housing 44 about the horizontal pivot points 46. As another example, the actuator 50 may provide a rotary input to the housing 44. For example, the actuator 50 may be between the housing 44 and the casing 12 at one or both horizontal pivot points 46 and may exert a rotational force at the horizontal pivot point 46 to rotate the housing 44 relative to the casing 12.

The rotational motor 18 and reflector assembly 20 are operable to align the field of illumination FOI with the field of view FOV of the photodetector 16. Specifically, the rotational motor 18 rotationally adjusts the rotational shaft 22 to steer the light beam vertically.

With reference to FIGS. 2-5, the casing 12 may, for example, enclose the other components of the system 10 and may include mechanical attachment features to attach the casing 12 to the vehicle 26 and electronic connections to connect to and communicate with electronic systems of the vehicle 26, e.g., components of the ADAS. The casing 12, for example, may be plastic or metal and may protect the other components of the system 10 from environmental precipitation, dust, etc. The system 10 may be a unit. In other words, the light source, the photodetectors 16, and the controller 28 may be supported by the casing 12.

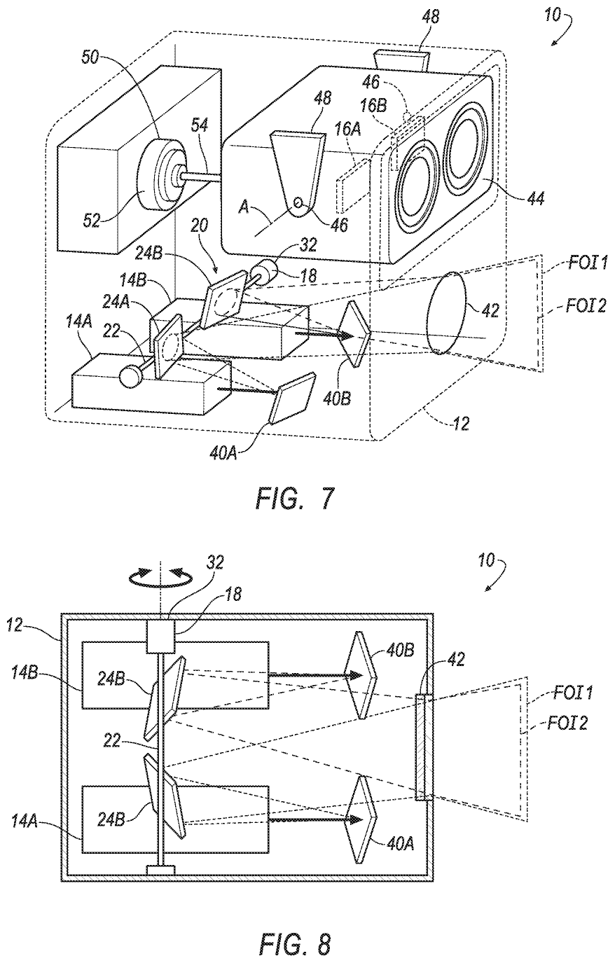

One embodiment of the system 10 is shown in FIG. 2, another embodiment is shown in FIGS. 4-6, another embodiment is shown in FIGS. 7-8, and another embodiment is shown in FIG. 10. Common numerals are used to identify common features among the embodiment.

With reference to FIG. 2, the system 10 may include one light emitter 14, one reflector 24 on the reflector assembly 20, and one photodetector 16. In this example, the field of view FOV of the photodetector 16 may be vertically adjusted by pivoting the housing 44, and the field of illumination FOI may be aligned with the field of view FOV by rotationally adjusting the rotational motor 18.

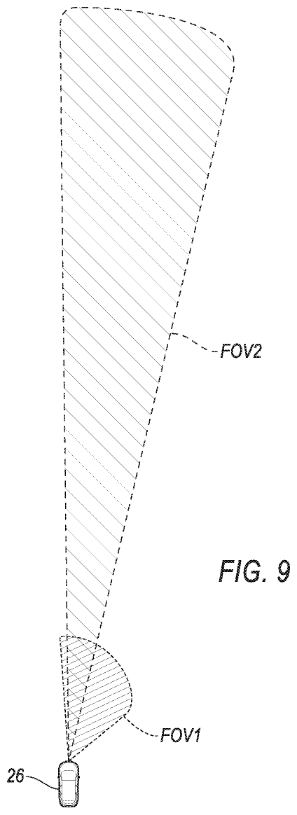

With reference to FIGS. 4-6, the system 10 may include two light emitters 14A, 14B, one reflector 24 on the rotational shaft 22, and two photodetectors 16A, 16B. The photodetectors 16A, 16B may each have a field of view FOV, as shown in FIG. 9. One of the light emitters 14 creates a field of illumination FOI for one of the photodetectors 16, and the other light emitter 14 creates a field of illumination FOI for the other photodetector 16. In FIGS. 4-6, both light emitters 14A, 14B are aimed at the reflector 24. The reflector 24 may reflect both light beams through one refractive diffuser 42. The photodetectors 16A, 16B are both fixed to the housing 44 and are simultaneously adjusted when the housing 44 is pivoted. Rotation of the rotational motor 18 adjusts the position of the reflector 24 to steer light from both lasers.

With reference to FIGS. 7 and 8, the system 10 may include two light emitters 14A, 14B, two reflectors 24A, 24B on the rotational shaft 22, and two photodetectors 16A, 16B. The photodetectors 16A, 16B may each have a field of view FOV, as shown in FIG. 9. One of the light emitters 14 creates a field of illumination FOI for one of the photodetectors 16, and the other light emitter 14 creates a field of illumination FOI for the other photodetector 16. In FIGS. 7 and 8, one light emitter 14 is aimed at one reflector 24 and the other light emitter 14 is aimed at the other reflector 24. The reflectors 24A, 24B may reflect both light beams through one refractive diffuser 42. The photodetectors 16A, 16B are both fixed to the housing 44 and are simultaneously adjusted when the housing 44 is pivoted. Rotation of the rotational motor 18 adjusts the position of the reflectors 24A, 24B to steer light from both lasers.

With reference to FIG. 10, the system 10 may include four light emitters 14A, 14B, 14C, 14C, four reflectors 24A, 24B, 24C, 24D on the rotational shaft 22, and four photodetectors 16A, 16B, 16C, 16D. The photodetectors 16A, 16B, 16C, 16D may each have a field of view FOV, as shown in FIG. 11. Each light emitter 14 is dedicated to one photodetector 16. In FIG. 10, one light emitter 14 is aimed at each reflector 24. The reflectors 24 may reflect the four light beams through one refractive diffuser 42. The four photodetectors 16A, 16B, 16C, 16D are fixed to the housing 44 and are simultaneously adjusted when the housing 44 is pivoted. Rotation of the rotational motor 18 adjusts the position of the four reflectors 24A, 24B, 24C, 24D to steer light from the four lasers.

As set forth above, the controller 28 is schematically shown in FIG. 15. The controller 28, i.e., the processor of the controller 28, is programmed to execute instructions stored in memory of the controller 28.

The controller 28 is programmed to receive data from the photodetectors 16 indicating detection of light from the light emitter 14 that was reflected by an object in the field of illumination FOI. As described above, this data is used for environmental mapping.

The controller 28 is programmed to adjust the vertical aim of the photodetector 16 (i.e., to vertically adjust field of view FOV) and the vertical aim of the field of illumination FOI, i.e., the vertical aim of the reflector 24. Specifically, the controller 28 is in communication with the actuator 50 for vertically adjusting the aim of the photodetectors 16.

The controller 28 may be programmed to receive indication that the field of view FOV needs adjustment. For example, it may be detected that the field of view FOV is vertically offset from a horizontal position, e.g., horizon, to a degree that the field of view FOV needs to be readjusted. As an example, the field of view FOV may change when the ride-height and/or angle of the vehicle 26 change, as described above. In response to such an indication, the controller 28 adjusts the position of the photodetector 16. For example, the controller 28 pivots the photodetector 16 to vertically position the field of view FOV to a desired position, e.g., to a horizontal position. Specifically, the controller 28 may pivot the housing 44 relative to the casing 12, which adjusts the field of view FOV of the photodetector 16 because the photodetector 16 moves as a unit with the housing 44. For example, the controller 28 may be programmed to power the actuator 50 to pivot the housing 44. In the example in which the actuator 50 is the motor, the actuator 50 may be powered to extend or retract the plunger 54 to move the housing 44 relative to the casing 12.

Based on this adjustment, the controller 28 is programmed to adjust the positions of the rotational motor 18 to vertically adjust the field of illumination FOI to align the field of illumination FOI with the field of view FOV. In other words, the rotational motor 18 is adjusted in response to adjustment of the field of view FOV to align the field of view FOV and the field of illumination FOI. Specifically, the field of illumination FOI may be adjusted vertically to align the field of view FOV and the field of illumination FOI.

After the position of the photodetector 16 has been set for the new vehicle position as described above, the controller 28 is programmed to adjust the rotational motor 18 and/or the actuator 50 to align the field of illumination FOI with the field of view FOV, i.e., adjusting the vertical positions of the field of view FOV and/or the vertical position of the field of illumination FOI to align the field of view FOV and the field of illumination FOI. As one example, the controller 28 may set the position of the field of view FOV, i.e., set the position of the actuator 50, and vertically adjust the field of illumination FOI to align the two, i.e., by changing the rotational position of the rotational motor 18. In addition to adjusting the rotational motor 18 in such an example, the controller 28 may adjust the actuator 50, e.g., +/− a predetermined adjustment angle of the field of view FOV from the set position, to align the field of view FOV with the field of illumination FOI.

As set forth above, the alignment of the field of view FOV and the field of illumination FOI may be based on maximum detection of reflected light on an object in the field of view FOV at each position of the rotational motor 18. In other words, the controller 28 is programmed to vertically adjust the rotational motor 18 and/or the actuator 50 to align the field of view FOV and the field of illumination FOI to the position that provides the maximum intensity of light reflected by an object in the field of view FOV.

In such an example, the controller 28 is programmed to identify changes in intensity of light reflected by an object in the field of view FOV as the rotational motor 18 and/or actuator 50 are adjusted. As an example, the controller 28 may be programmed to set the position of the field of view FOV and scan through various vertical positions of the field of illumination FOI to identify the position of the field of illumination FOI that provides the maximum intensity of detected reflections, considering the entire field of view FOV. For example, the controller 28 may be programmed to scan through a range of adjustments and activate the light emitter 14 during the scan. Based on the detected reflections by the photodetector 16, the controller 28 may be programmed to determine the setting of the rotational motor 18 that provides the maximum intensity reflection. The controller 28 then uses this setting to position the rotational motor 18 during illumination of the field of view FOV. In examples that include more than one photodetector 16, the controller 28 may be programmed to perform the adjustment for any one of the photodetectors 16, all of the photodetectors 16, or a combination of the photodetectors 16.

In the example in which the position of the photodetectors 16 is also adjusted to align the field of view FOV and the field of illumination FOI, the field of view FOV may be set to several other positions and the controller 28 scans through the various vertical positions of the field of illumination FOI at each of these positions of the field of view FOV. During the scanning of the various vertical positions of the field of view FOV and the various vertical positions of the field of illumination FOI, the combination of the vertical position of the field of view FOV and the vertical position of the field of illumination FOI that provide the maximum illumination of reflections in the field of view FOV may be identified. In other words, the controller 28 is programmed to determine the position of the rotational motor 18 and the actuator 50 that provide the maximum intensity of light reflected by an object in the field of view FOV. Once these positions are identified, the processor is programmed to adjust the rotational motor 18 and the actuator 50 to these positions, i.e., to center the field of illumination FOI on the field of view FOV based on the changes in intensity. Additionally, information obtained from an inertial measurement unit 56 may indicate to the controller 28, that an adjustment should be made.

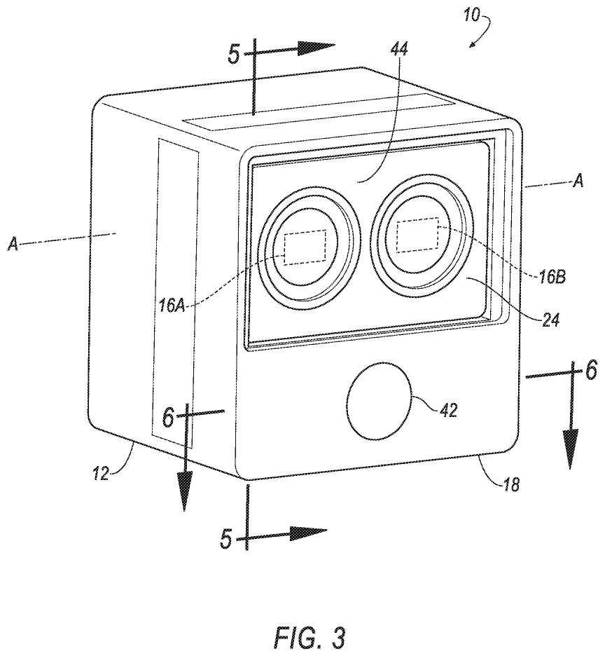

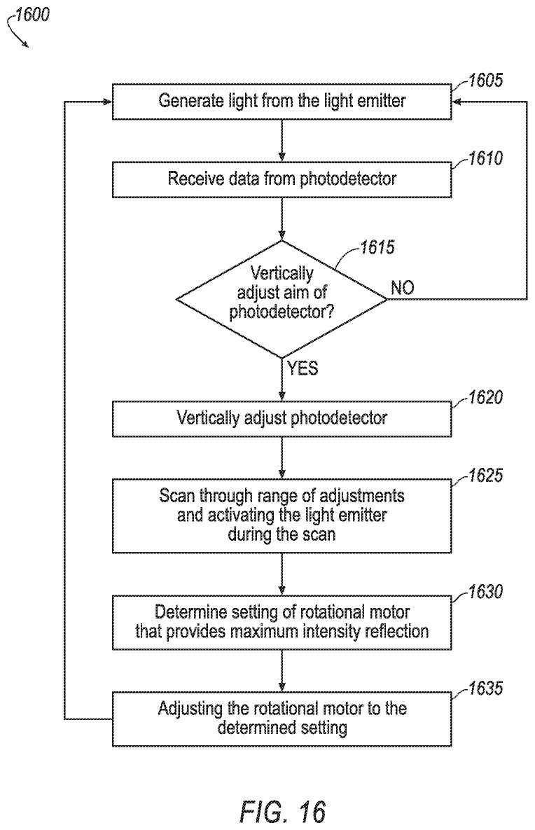

A method 1600 of operating the system 10 is shown in FIG. 16. The method 1600 is a method of operating the example shown in FIG. 2, and also includes the steps of operating the examples shown in FIGS. 3-11. The controller 28 may be programmed to perform the method of FIG. 16.

With reference to block 1605, the method includes activating the light emitter 14 aimed at the mirror assembly including a rotary shaft and a mirror to generate a field of illumination FOI. In block 1610, the method includes receiving data from the photodetector 16 corresponding to detected reflection of light from the light emitter 14 in the field of view FOV of the photodetector 16. The method includes repeating blocks 1605 and 1610 to repeatedly illuminate the field of view and detect reflections.

In examples that include more than one light emitter 14 and/or more than one photodetector 16, steps 1605 and 1610 include activating more than one light emitter 14 and receiving data from more than one photodetector 16. For example, step 1605 may also include activating the second light emitter 14B aimed at the reflector assembly 20 to generate the second field of illumination FOI. Similarly, step 1610 may also include receiving data from the second photodetector 16B indicating detection of light from the light emitter 14 that was reflected by an object in a field of view FOV of the second photodetector 16B. As set forth above, two of the light emitters 14 may be aimed at the same reflector 24 of the reflector assembly 20, or two of the light emitters 14 may be aimed at separate reflectors 24 of the reflector assembly 20.

Decision block 1615 includes the decision that the photodetector 16 requires vertical adjustment, as described above. If the photodetector 16 does not require vertical adjustment, blocks 1605 and 1610 continue to be repeated. If the photodetector 16 does require vertical adjustment, the photodetector 16 is vertically adjusted, e.g., by operation of the actuator 50, and the reflector 24 is vertically adjusted, e.g., by rotation of the rotational motor 18, to align the field of illumination FOI with the field of view FOV, as shown in blocks 1620-1635. Decision block 1615 could be at any point before, during, or after blocks 1605 and 1610.

Block 1620 includes vertically adjusting a position of the photodetector 16. For example, block 1620 may include pivoting the housing 44 relative to the casing 12, which adjusts the field of view FOV of the photodetector 16 because the photodetector 16 moves as a unit with the housing 44. Specifically, the method may include powering the actuator 50 to extend or retract the plunger 54 to move the housing 44 relative to the casing 12. The system 10 itself may determine the desired position to be set in block and/or the desired position may be based on data and/or instruction from other components of the vehicle 26.

Block, 1625 includes rotating the rotary shaft to align the field of illumination FOI with the field of view FOV. For example, the method includes scanning through a range of adjustments and activating the light emitter 14 during the scan. In an example including a second photodetector 16, rotating the rotary shaft in step 1625 may also rotating the rotary shaft to align the second field of illumination FOI with the field of view FOV of the second photodetector 16.

At block 1630, the method includes determining the setting of the rotational motor 18 that provides the maximum intensity reflection within the field of view FOV. In other words, block 1630 includes identifying changes in intensity of reflections over the entire field of view FOV as the rotational shaft 22 is rotated and/or the photodetector 16 is adjusted, and determining the rotational position of the rotational shaft 22 and the position of the photodetector 16 that provide the maximum intensity of light reflected by an object in the field of view FOV. Specially, at each position, the method includes activating the light emitter 14, receiving data from the photodetector 16 indicating detection of light from the light emitter 14 that was reflected by an object in a field of view FOV, and adjusting the rotational motor 18 to vertically align the field of view FOV with the field of illumination FOI. Specifically, in blocks 1630, the method includes setting the position of the field of view FOV and scanning through various adjustments of the field of illumination FOI. This data is used to identify the position of the field of illumination FOI that provides the maximum intensity of detected reflections.

At block 1635, the method includes adjusting the rotational motor 18 to the setting that was determined to provide the maximum intensity in block 1630. Accordingly, when steps 1605 and 1610 are subsequently performed, the rotational motor 18 and actuator 50 are set to provide maximum intensity of detected reflections in the field of view FOV.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system comprising:
a casing;
a light emitter stationary relative to the casing;
a photodetector pivotally supported by the casing;
a rotational motor supported by the casing; and
a reflector assembly including a rotational shaft and a reflector fixed to the rotational shaft, the rotational shaft engaged with the rotational motor and the reflector fixed to the rotational shaft, the light emitter being aimed at the reflector assembly.

2. The system of claim 1, further comprising a second light emitter stationary relative to the casing and a second photodetector pivotally supported by the casing.

3. The system of claim 2, wherein the reflector assembly includes a second reflector fixed to the rotational shaft.

4. The system of claim 3, wherein the light emitter is aimed at the reflector and the second light emitter is aimed at the second reflector.

5. The system of claim 2, wherein the light emitter and the second light emitter are aimed at the reflector.

6. The system of claim 1, further comprising a housing supporting the photodetector and pivotally engaged with the casing and an actuator between the housing and the casing.

7. The system of claim 6, wherein the housing is pivotable relative to the casing about a horizontal axis.

8. The system of claim 6, further comprising a second photodetector pivotally supported by the housing.

9. The system of claim 1, further comprising a vibration dampener engaged with the rotational shaft.

10. The system of claim 9, wherein the vibration dampener is designed to dampen high-frequency vehicle vibration.

11. A method comprising:
activating a light emitter aimed at the reflector assembly including a rotational shaft and a reflector to generate a field of illumination;
receiving data from a photodetector indicating detection of light from the light emitter that was reflected by an object in a field of view of the photodetector;
adjusting a position of the photodetector; and
rotating the rotational shaft to align the field of illumination with the field of view.

12. The method as set forth in claim 11, further comprising activating a second light emitter aimed at the reflector assembly to generate a second field of illumination and receiving data from a second photodetector indicating detection of light from the light emitter that was reflected by an object in a field of view of the second photodetector.

13. The method as set forth in claim 12, wherein rotating the rotational shaft includes rotating the rotational shaft to align the second field of illumination with the field of view of the second photodetector.

14. The method as set forth in claim 12, wherein the light emitter and the second light emitter are aimed at the reflector of the reflector assembly.

15. The method as set forth in claim 12, wherein the light emitter is aimed at the reflector of the reflector assembly and the second light emitter is aimed at a second reflector of the reflector assembly.

16. The method as set forth in claim 11, further comprising identifying changes in intensity of reflections in the field of view as the rotational shaft is rotated and/or the photodetector is adjusted.

17. The method as set forth in claim 11, further comprising determining the rotational position of the rotational shaft and the position of the photodetector that provide the maximum intensity of light reflected by an object in the field of view.

18. The method as set forth in claim 11, wherein adjusting the position of the photodetector includes vertically adjusting the position of the photodetector and wherein rotating the rotational shaft vertically aligning the field of illumination with the field of view.

19. The method as set forth in claim 11, wherein adjusting the position of the photodetector includes instructing an actuator to pivot a housing relative to the casing, the housing supporting the photodetector and pivotally supported by the casing.

20. A controller comprising a processor and a memory storing instructions executable by the processor, wherein the processor is programmed to:
activate a light emitter aimed at the reflector assembly including a rotational shaft and a reflector to generate a field of illumination;
receive data from a photodetector indicating detection of light from the light emitter that was reflected by an object in a field of view of the photodetector;
adjust a position of the photodetector; and
rotate the rotational shaft to align the field of illumination with the field of view.

21. The controller as set forth in claim 20, wherein the processor is programmed to activate a second light emitter aimed at the reflector assembly to generate a second field of illumination and receive data from a second photodetector indicating detection of light from the light emitter that was reflected by an object in a field of view of the second photodetector.

22. The controller as set forth in claim 21, wherein the processor is programmed to rotate the rotational shaft to align the second field of illumination with the field of view of the second photodetector.

23. The controller as set forth in claim 20, wherein the processor is programmed to identify changes in intensity of reflections in the field of view as the rotational shaft is rotated and/or the photodetector is adjusted.

24. The controller as set forth in claim 20, wherein the processor is programmed to determine the rotational position of the rotational shaft and the position of the photodetector that provide the maximum intensity of light reflected by an object in the field of view.

25. The controller as set forth in claim 20, wherein the processor is programmed to vertically adjust the position of the photodetector and vertically align the field of illumination with the field of view.

26. The controller as set forth in claim 20, wherein the processor is programmed to instruct an actuator to pivot a housing relative to the casing, the housing supporting the photodetector and pivotally supported by the casing.
